(19) United States
(12) Patent Application Publication
(10) Pub. No.: US 2007/0084036 A1
(43) Pub. Date: Apr. 19, 2007

(54) END-WISE CONNECTION OF SECOND CHIMNEY COMPONENTS AND METHOD THEREFOR

(76) Inventor: Benoit Gagne, Terrebonne (CA)

Correspondence Address: AKERMAN SENTERFITT, P.O. BOX 3188, WEST PALM BEACH, FL, 33402-3188, US

(21) Appl. No.: 11/459,236

(22) Filed: Jul. 21, 2006

Related U.S. Application Data
(62) Division of application No. 10/872,308, filed on Jun. 18, 2004.

(30) Foreign Application Priority Data
Jun. 18, 2003 (CA) 2,432,703

(51) Int. Cl. B21D 39/03; B23P 25/00

(52) U.S. Cl. 29/458; 29/428; 29/464

(57) ABSTRACT

A joint assembly and method for end-wise connection of two chimney components wherein each component has an open end section with a flanged extremity. The assembly includes an inner tubular collar having one end insertable in one end section of a first chimney component and an opposite end insertable in one end section of a second chimney component. A tubular band is mounted exteriorly to the collar. The flange extremity of the first chimney component is connected to the flange extremity of the second chimney component so as to secure the end sections to one another with the collar and the tubular band mounted therein.

### CROSS REFERENCE TO RELATED APPLICATIONS

This application is a divisional patent application of co-pending U.S. patent application Ser. No. 10/872,308, filed on Jun. 18, 2004, the entire contents of which are hereby incorporated by reference, and Canadian Patent Application Serial No. 2,432,703, filed on Jun. 18, 2003.

### FIELD OF THE INVENTION

The present invention relates to a joint assembly for end-wise connection of two chimney components.

### BACKGROUND OF THE INVENTION

Chimney systems permit the exhaust of combustion gases, under positive, negative or neutral pressure, emanating from a variety of appliances including, but not limited to, diesel engine and gas turbine exhausts, industrial oven exhausts, restaurant grease ducts, boilers, incinerators, etc.

The various components of known factory-built positive pressure chimney systems include lengths, expansion joints, tees, elbows, etc. These components typically have a flange-to-flange end at their jointing point. These flanges are joined together by aligning the flanges together. They are then joined together by means of a v-shaped assembly band, which is clamped around the flanges of both parts. A sealant is applied in the groove of the v-band before it is clamped to the flanges.

There is still room in the art for a joint assembly for end-wise connection of two chimney components and a method therefor.

### SUMMARY OF THE INVENTION

More specifically, there is provided a joint assembly for end-wise connection of a first and a second chimney component, each one of the first and second chimney components having an open end section with a flanged extremity, comprising:

an inner tubular collar having one end insertable in the open end section of the first chimney component and an opposite end insertable in the open end section of the second chimney component; and

connection means fixedly securing the flanged extremity of the first chimney component to the flanged extremity of the second chimney component to secure the end section of the first chimney component to the end section of the second chimney component with the inner tubular collar.

There is further provided a method for end-wise connection of a first and second chimney component in a joint assembly, each one of the first and second chimney component having an open end section with a flanged extremity, comprising the steps of:

a) inserting an inner tubular collar in the open end section of the first chimney component:

b) applying a sealant circumferentially on the flanged extremity of the open end section of the second chimney component; and

c) moving the first chimney component in engagement with the second chimney component.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 is an elevational view showing a joint assembly prior to an interconnection of two chimney components

FIG. 2 is an elevational view showing the joint assembly of FIG. 1, with the two chimney components interconnected;

FIG. 3 is an enlarged view of an assembly band and of attaching bands securing a joint assembly; and

FIG. 4 is an illustration of one half of an attaching band as used in FIG. 3.

### BRIEF DESCRIPTION OF THE EMBODIMENTS OF THE INVENTION

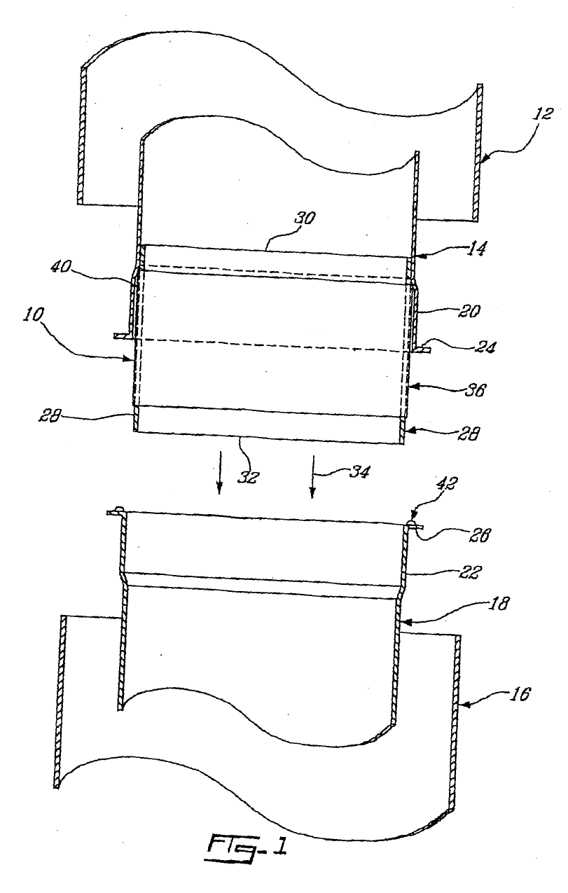

Referring to FIG. 1, there is shown a joint assembly generally denoted 10, for connecting two chimney components, identified as A and B. In the embodiment illustrated, the two chimney components A and B are two lengths of a double wall chimney construction consisting of an outer wall 12 and an inner wall 14 for chimney component A, and an outer wall 16 and an inner wall 18 for chimney component B.

The inner wall 14, 18 of each chimney component defines an open end section 20, 22 having a diameter slightly greater than a diameter of the remaining portion of the wall. Each end section 20, 22 has a flanged extremity 24, 28.

The joint assembly 10 comprises an inner tubular collar 28 having one end 30 insertable in the open section 20 of the chimney component A and an opposite end 32 insertable in the end section 22 of chimney B (as indicated by the arrows 34).

In the cases of high temperature applications, a tubular band 36 made of ceramic fiber may be circumferentially and exteriorly mounted over part of an outer wall of the collar 28.

The end-wise connection of chimney component A to chimney component B will now be described. First, the collar 28 is inserted in the end connection 20 of chimney component A. The upper end 30 of the collar is welded, for example seam welded or spot-welded to the inner wall of the end section 20. When a tubular band 36 is used, it is then inserted between the collar 25 and the end section 20 and is fixed therein by means of an adhesive 40. Subsequently, a sealant 42, such as a silicone, is applied circumferentially on the flanged extremity 26 of the chimney component B. Chimney component A with the joint assembly 10 is then moved as indicated by arrows 34 to engage the chimney component B.

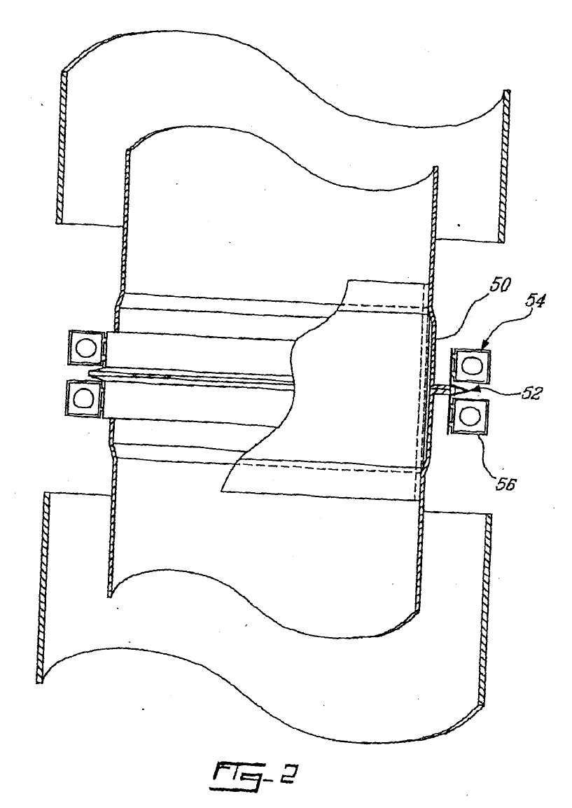

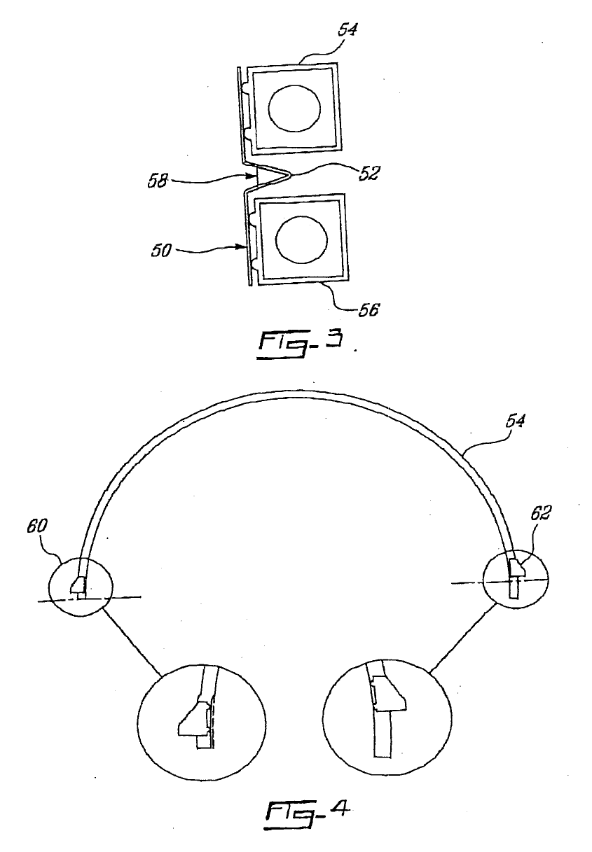

Referring to FIG. 2, where the two chimney components A and B are shown engaged to one another, the connection is further secured by means of an assembly band 50, having a V-shaped mid section 52, to which a pair of attaching bands 54 and 56 are mounted exteriorly. The pair of attaching bands 54 and 56 is welded to the assembly band 50. A silicon material 56 is deposited in the V-shaped section 52 of the assembly band 50. The assembly band 50 and attaching bands 54 and 56 are placed in a manner that the flanged extremities 24, 26 sealed to one another are received within the midsection 52 of the assembly band to which they are further sealed due to the adhesive 56.

FIG. 4 illustrates the construction of the extremities 60 and 62 of an attaching band so that a full ring may be formed.

Although the present invention has been described hereinabove by way of embodiments thereof, it may be modified, without departing from the nature and teachings of the subject invention as defined in the appended claims.

What is claimed is:

1. A method for end-wise connection of a first and a second chimney component in a joint assembly, each one of the first and second chimney components having an open end section with a flanged extremity, comprising the steps of:
a) inserting an inner tubular collar in the open end section of the first chimney component;
b) applying a sealant circumferentially on the flanged extremity of the open end section of the second chimney component; and
c) moving the first chimney component in engagement with the second chimney component.

2. The method of claim 1, further comprising after step a) the step of welding an upper end of the inner tubular collar to an inner wall of the open end section of the first chimney component.

3. The method according to claim 1, further comprising, prior to step b) the steps of inserting a tubular band between the inner tubular collar and the open end section of the first chimney component and of fixing the tubular band therein.

4. The method according to claim 1, further comprising a step d) of securing the connection with an assembly band.

5. The method according to claim 4, wherein said step d) comprises providing an assembly band with a V-shaped mid section, mounting exteriorly to the assembly band a pair of attaching bands, depositing a silicone material in the V-shaped mid section of the assembly band; placing the assembly band with the attaching bands to receive the first and second flanged extremities sealed together.
